(19) United States
(12) Patent Application Publication
(10) Pub. No.: US 2024/0330856 A1
(43) Pub. Date: Oct. 3, 2024

(54) INFORMATION PROCESSING DEVICE

(71) Applicant: TOYOTA JIDOSHA KABUSHIKI KAISHA, Toyota-shi (JP)

(72) Inventors: Iwao Nitta, Nagoya-shi (JP); Teruyoshi Fujiwara, Toyota-shi (JP); Ryota Suzuki, Ikeda-shi (JP)

(73) Assignee: TOYOTA JIDOSHA KABUSHIKI KAISHA, Toyota-shi (JP)

(21) Appl. No.: 18/543,044

(22) Filed: Dec. 18, 2023

(30) Foreign Application Priority Data
Mar. 29, 2023 (JP) 2023-053918

(51) Int. Cl. G06Q 10/0875

(52) U.S. Cl. CPC G06Q 10/0875

(57) ABSTRACT

The control unit of the information processing device obtains a designation as to whether or not to release the part numbers controlled by the subject company with respect to the subject product of the subject company to the company to which the product information of the subject product is to be released. The control unit of the information processor generates different pseudo part numbers for each company to which the product information of the target product is to be released when it is specified that the part numbers are not to be released. The control unit of the information processing device then outputs the generated pseudo part number instead of the part number.

### CROSS-REFERENCE TO RELATED APPLICATION

This application claims priority to Japanese Patent Application No. 2023-053918 filed on Mar. 29, 2023 incorporated herein by reference in its entirety.

### BACKGROUND

### 1. Technical Field

The present disclosure relates to an information processing device.

### 2. Description of Related Art

Japanese Unexamined Patent Application Publication No. 2004-171146 (JP 2004-171146 A) proposes a communication system in which a supply chain consisting of multiple companies and a management server that manages data among the multiple companies constituting the supply chain are connected via communication lines. In the proposed system, the management server has a contract database, a transaction product database, and a transaction condition database. The contract database stores company information of companies that have concluded a contract and contract unique identification data (ID) corresponding to the contract. The transaction product database stores product information of products for which contracts have been concluded. The transaction condition database stores vendor-side and customer-side individual information for each contract unique ID of the concluded contract. The management server is configured to retrieve the vendor-side and the customer-side individual information stored in the transaction condition database using the contract unique ID of the concluded contract as a key, and to perform code translation of the vendor-side and the customer-side individual information.

### SUMMARY

The purpose of this disclosure is to enable the management of transaction status of target products while ensuring the confidentiality of the transactions of the target products.

An information processing device according to the present disclosure includes a control unit that is configured to execute:
with regard to a target product of a target company, obtaining designation of whether to release a part number managed by the target company to a company to which product information of the target product is released;
when it is designated that the part number is not to be released, generating a different pseudo part number for each of the companies to which the product information of the target product is released; and
outputting the generated pseudo part number instead of the part number.

The present disclosure enables the management of transaction status of target products while ensuring the confidentiality of the transactions of the target products.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 shows a schematic diagram of the information processing system; and

FIG. 2 illustrates an example of the relationship between products supplied by the supply chain; and

FIG. 3 is a block diagram outlining an example of the software configuration of a server; and

FIG. 4 shows an example of the table structure of tree information held in the tree information database; and

FIG. 5 shows an example of the table structure of part number information held in the part number information database; and

FIG. 6 is a flowchart of the process executed by the control unit at the server.

### DETAILED DESCRIPTION OF EMBODIMENTS

Consider a case where a product is supplied by a supply chain that includes several companies. Throughout such a supply chain, it may be required to collect product information about the product. At least some of the product information collected may be shared among different companies for information use purposes, such as generating a product tree corresponding to the supply chain. In this case, if the product information to be disclosed includes the product part number, the disclosure of the part number to multiple companies may lead to the identification of highly confidential information, such as product transaction relationships in the supply chain, by unintended parties. For example, by cross-checking published part numbers, the fact that the same product with the same part number is delivered from one company to multiple companies could be identified. On the other hand, if product part numbers are not disclosed, it becomes difficult to identify the products traded between companies themselves. The information processing device of the present disclosure solves such problems.

The control unit of the information processing device pertaining to this disclosure obtains a designation of whether or not to release the part numbers managed by the subject company with respect to the subject product of the subject company to the company to which the product information of the subject product is to be released. The control unit of the information processing device generates different pseudo part numbers for each company to which the product information of the target product is to be released when it is specified that the part numbers are not to be released. The control unit then outputs the generated pseudo part number instead of the part number.

As explained above, in the information processing device pertaining to the present disclosure, when it is specified that the part number of the target product is not to be disclosed, the pseudo part number is generated so that it differs for each company to which the product information of the target product is disclosed, and the generated pseudo part number is output. Since a different pseudo part number is assigned to each company to which the product information of the subject product is disclosed, even if the part numbers are cross-checked, a third party will not be able to identify the status of transactions between the companies. On the other hand, by referring to the pseudo-product number, companies related to the subject product can ascertain the status of transactions for the subject product. Therefore, it is possible to manage the status of transactions of the subject product while ensuring the confidentiality of the status of transactions of the subject product.

Hereinafter, embodiments of the present disclosure will be described with reference to the drawings. A hardware configuration, a module configuration, a functional configuration, etc., described in each embodiment are not intended to limit the technical scope of the disclosure to them only unless otherwise stated.

### EMBODIMENT

### System Overview

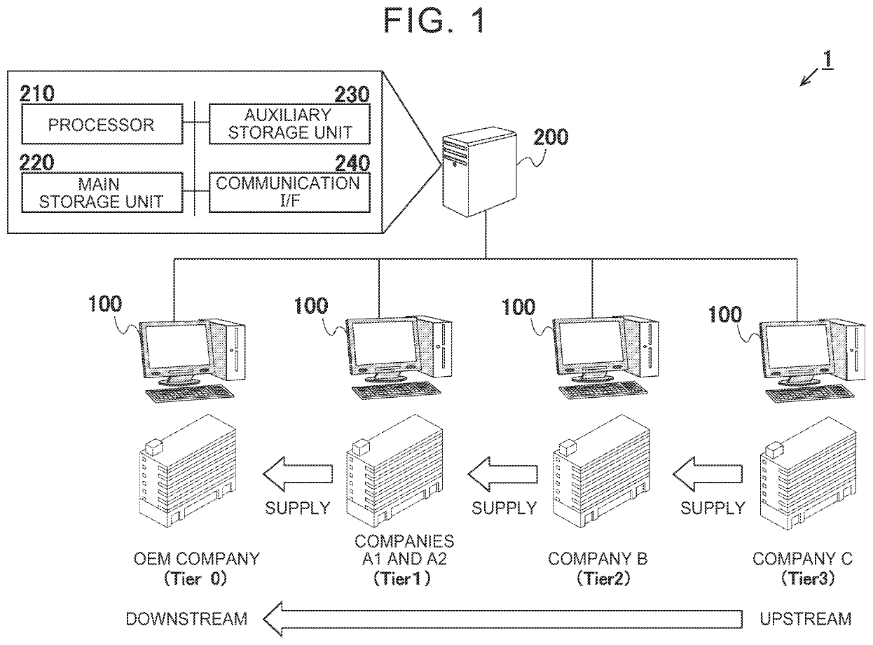

FIG. 1 is a diagram schematically illustrating a configuration of an information processing system 1. The information processing system 1 comprises a plurality of corporate terminals 100 and a server 200. In the information processing system 1, the corporate terminal 100 and the server 200 are interconnected by a network. For example, a Wide Area Network (WAN), a worldwide public communication network such as the Internet, may be employed for the network.

First, an example of a supply chain structure is described. In the example in FIG. 1, the supply chain includes an original equipment manufacturer (OEM) company and several supplier companies (companies A1, A2, B and C). An OEM company is one that assembles the final product. In addition, a supplier company (a company that is a supplier) is a company that, for example, supplies parts, materials, assemblies, etc. to manufacture a final product. Each supplier company produces several products and delivers them to the company located one level below it. Several companies repeat this process, and in the final step, the final product is assembled. The structure of the supply chain need not be limited to these examples. The companies that make up the supply chain may be determined as appropriate for the implementation. In another example, the supply chain may include companies that transport, import, store, wholesale, etc., products.

In this implementation, the side that delivers products in a certain hierarchy is referred to as the upstream side, and the side that purchases said products and produces new products is referred to as the downstream side. In this document, companies located upstream are referred to as upstream companies and companies located downstream are referred to as downstream companies. Products produced by upstream companies are referred to as upstream products, and products produced by downstream companies are referred to as downstream products. Downstream products encompass upstream products.

In this document, the tiers in the supply chain are also referred to as Tier. Tier 0 is the lowest tier where the final product is assembled (corresponding to the OEM company) and transitions upstream as you move through Tiers 1, 2, and 3. Depending on the hierarchy of focus, a downstream firm may be an upstream firm. For example, firm B, located in Tier 2, is a downstream firm in relation to Tier 3, but an upstream firm in relation to Tier 1. Thus, the definition of upstream and downstream companies can change from one hierarchy to another.

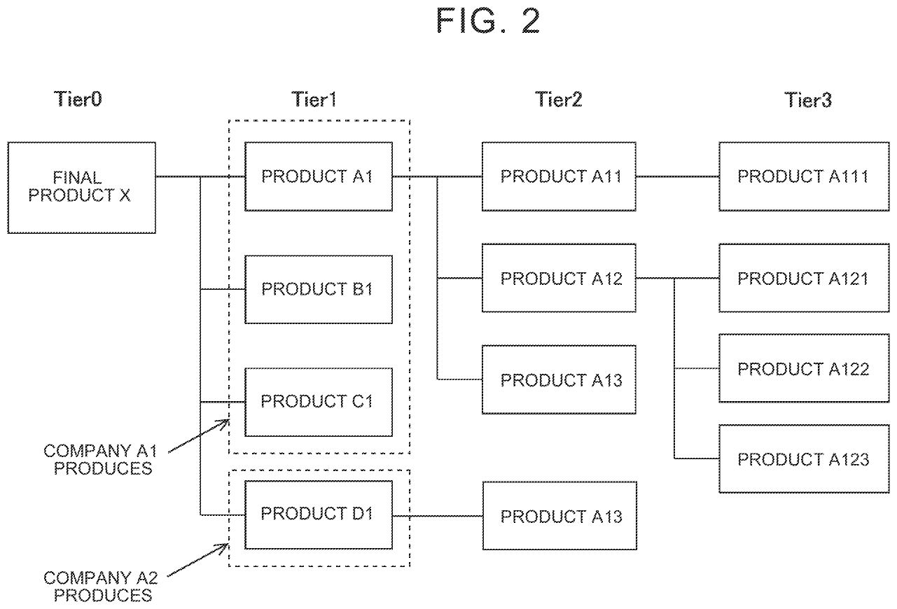

FIG. 2 illustrates an example of the relationship between products supplied by a supply chain. In FIG. 2, the supply relationship of the multiple products that make up the final product X is shown by means of a tree diagram. In the example shown in FIG. 2, final product X is produced by assembling products A1, B1, C1, and D1. Product A1 is also produced by assembling products A11, A12, and A13. Product D1 is also produced by using product A13. Thus, the relationship between the multiple products that make up the final product X can be represented by a tree diagram in which each individual product is a node.

In the example in FIG. 2, company A1, located in Tier 1, produces products A1, B1 and C1 and delivers each product to an OEM company located in Tier 0. Firm A2, located in Tier 1, produces product D1 and delivers product D1 to an OEM firm located in Tier 0. Firm B, located in Tier 2, produces products A11, A12, and A13 and delivers each product to firm A1, located in Tier 1. Firm B, located in Tier 2, delivers product A13 to firm A2, located in Tier 1. Firm C, located in Tier 3, produces products A111, A121, A122, and A123 and delivers each product to Firm B, located in Tier 2.

The final product X may be any product. In one example, the final product X may be a battery. The final product X is, for example, a battery to be installed in a vehicle. The battery in the vehicle may be a battery that provides electricity to the motor that drives the vehicle. Batteries installed in vehicles may be batteries used for auxiliary batteries. The final product X may be, for example, a stationary storage battery.

### Corporate Terminal

Corporate terminal 100 is a terminal associated with each supplier company. Corporate terminal 100 accepts input of product information about the products produced by each company. Product information is disclosed by each company to the companies to which it delivers products (downstream companies). Here, product information is information that indicates the status of transactions for products produced by each company. Product information includes an identifier to identify the company (company ID), the tier in which the company is located, and an identifier to identify the company to which the company delivers the product (supplier company ID). In addition, product information is information that includes the part numbers of the products that a company produces. The product information also contains information specifying whether or not to disclose the part number of the product to the company to which the product information is to be disclosed. The corporate terminal 100 sends product information to the server 200 via the network.

### Server

Server 200 is a device for managing product information about the products produced by each company in the supply chain. Assume that at least some companies in the supply chain have access to product information, including part numbers, along with supply relationships for the multiple products that make up the final product X shown in FIG. 2. Then, by referring to the part number of the product information, the company collecting the product information may be able to identify the status of transactions of the product between the company handling the product and other companies. On the other hand, if viewing of part numbers is prohibited, it is assumed that companies related to the product (companies that deliver the product or companies that receive delivery of the product) will not be able to identify the product, making it difficult to understand the status of transactions.

In the example in FIG. 2, assume that product information for product A1, which includes the part number of product A13, is released to company A2 and product information for product D1, which includes the part number of product A13, is released to company A1. In addition, assume that firm B assigned the same part number to product A13 and disclosed that part number to each of the companies (A1 and A2). In this case, company A1 may be concerned that company A2 may know that product A13 is used in product A1 (there is a business relationship between company A1 and company B) due to the part number of product A13 included in the product information of product A1. Similarly, company A2 may be able to let company A1 know that product A13 is used in product D1 (there is a business relationship between company A2 and company B) due to the part number of product A13 included in the product information of product D1.

Therefore, the server 200 obtains a designation as to whether or not to release the part numbers controlled by the subject company with respect to the subject product of the subject company to the company to which the product information of the subject product is to be released. If the server 200 is specified not to release the part number of the target product to the company to which the product information of the target product is to be released, the server 200 generates different pseudo part numbers for each company to which the product information of the target product is to be released. As an example, in the example in FIG. 2, if the target product is product A13 and it is specified that the part number managed by company B is not to be disclosed, different pseudo part numbers are generated for product A13 to be delivered to company A1 and for product A13 to be delivered to company A2. The server 200 then outputs the generated pseudo part number instead of the part number.

The server 200 comprises a computer having a processor 210, main memory 220, auxiliary storage unit 230, and communication interface (communication I/F) 240. Processor 210 is, for example, a Central Processing Unit (CPU) or Digital Signal Processor (DSP). The main memory 220 is, for example, Random Access Memory (RAM). Auxiliary storage unit 230 is, for example, Read Only Memory (ROM). The auxiliary storage unit 230 is, for example, a Hard Disk Drive (HDD) or a disk storage medium such as a CD-ROM, DVD disk, or Blu-ray disk. The auxiliary storage unit 230 may be a removable medium (a portable storage medium). Examples of the removable medium include a USB memory or an SD card. The communication I/F 240 is, for example, a Local Area Network (LAN) interface board or a wireless communication circuit for wireless communication.

In server 200, auxiliary storage unit 230 stores an operating system (OS), various programs, and various information tables. In the server 200, the processor 310 can load the program stored in the auxiliary storage unit 230 into the main memory 220 and execute it to realize various functions (software modules) as described below. However, some or all of the functions in server 200 may be realized by hardware circuits (hardware modules) such as ASICs or FPGAs. The server 200 does not necessarily have to be realized by a single physical configuration, but may be composed of multiple computers that are linked to each other. The corporate terminal 100, like the server 200, also comprises a computer.

### Software Configuration

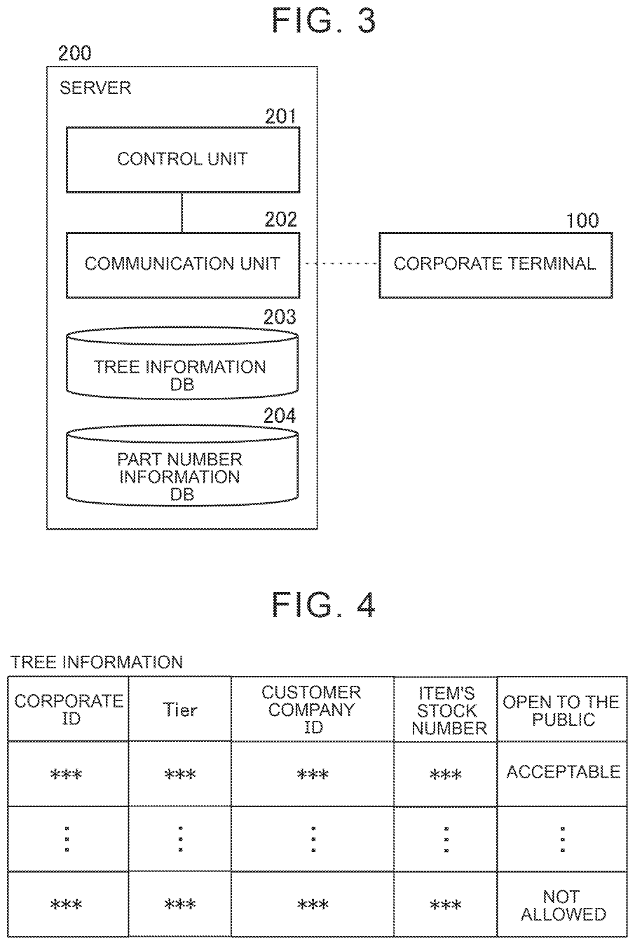

Next, a software configuration of the server 200 constituting the information processing system 1 is explained based on FIGS. 3 to 5. FIG. 3 is a block diagram outlining an example of the software configuration of the server 200.

The server 200 comprises a control unit 201, a communication unit 202, a tree information database 203 (tree information DB 203), and a part number information database 204 (part number information DB 204). The control unit 201 is configured to perform arithmetic operations to control the server 200. Control unit 201 may be configured by processor 210. The communication unit 202 is configured to perform operations (sending/receiving data) that connect the server 200 to the network. The communication unit 202 may be configured by a communication I/F 240.

The control unit 201 receives product information from the corporate terminal 100 associated with each company in the supply chain via the communication unit 202. The control unit 201 stores product information about each company in the tree information held in the tree information DB 203. The tree information DB 203 is configured to hold tree information. Tree information includes product information received from multiple companies in the supply chain. The tree information DB 203 may be configured by auxiliary storage unit 230. FIG. 4 shows an example of the table structure of tree information maintained in the tree information DB 203.

The tree information has a company ID field, a Tier field, a supplier company ID field, a part number field, and a publication designation field. The Company ID field contains a company ID to identify multiple companies in the supply chain. The Tier field contains information indicating the Tier in which the company corresponding to the company ID stored in the Company ID field is located. The supplier company ID field contains the supplier company ID of the company to which the company corresponding to the company ID stored in the company ID field delivers products. The part number field contains the part number of the product that the company corresponding to the company ID stored in the company ID field is delivering to the supplier company. For example, the part number contained in the information stored in the part number field is the part number assigned by the company corresponding to the company ID stored in the company ID field.

In the Publication Designation field, the status of whether or not to publish the part number stored in the Part Number field to the company to which the product information is to be published is entered. In the Publication Designation field, “Yes” is entered if the part number stored in the Part Number field is to be published to the company to which the product information is to be published. In other words, if “Yes” is entered in the “Publication Designation” field, the product corresponding to the part number stored in the part number field is disclosed to the company to which the product information is disclosed using that part number. In addition, “Not Allowed” is entered in the Publication Designation field if the company to which the product information is to be published is not allowed to publish the part number stored in the Part Number field. Whether or not to release the part number stored in the part number field in the publication designation field to the company to which the product information is to be released may be specified collectively for all products to be produced, or may be specified for each product. The format of the information indicating “acceptable” and “not acceptable” may be determined arbitrarily.

By referring to the tree information held in the tree information DB 203, the control unit 201 can ascertain the supply relationship of multiple products comprising the final product X in the supply chain. By referring to the tree information maintained in the tree information DB 203, the control unit 201 can ascertain whether or not the part number of each product may be disclosed to the company to which the product information is disclosed.

The part number information DB 204 is configured to hold part number information. The part number information DB 204 may be configured by auxiliary storage unit 230. Auxiliary storage unit 230 is an example of a predetermined storage area. However, the storage destination of the part number information DB 204 need not be limited to this and may be selected arbitrarily. In another example, at least part of the part number information DB 204 may be stored in other storage devices, such as, for example, main memory 220, storage devices of other computers (e.g., external servers such as NAS), etc. The part number information indicates the correspondence between the part number of each product and the pseudo-part number of each product. Part number information is an example of part number management information. The part number information includes information indicating the correspondence between the part number of each product and the pseudo-part number generated by the server 200. The part number information may also include information indicating the correspondence between the part number of each product and the pseudo-part number of each product, which is maintained on other platforms (external platforms). Here, an external platform is, for example, a platform that manages product part numbers in other supply chains. In one example, an external platform may manage product information for companies in the supply chain managed by the platform configured by the server 200 (hereinafter also described as its own platform). Then, on said external platform, the products of the companies in the supply chain managed by its own platform may be managed by pseudo part numbers.

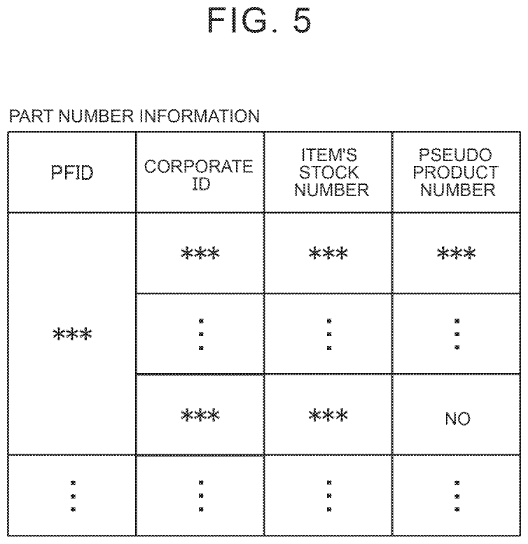

FIG. 5 shows an example of the table structure of part number information held in the part number information DB 204. The part number information has a PFID field, a company ID field, a part number field, and a pseudo part number field. The PFID field contains an identifier (PFID) to identify the platform that manages the supply chain part number. When managing the part number of one's own platform, the PFID field of the target record will contain the PFID of one's own platform. On the other hand, when managing the part number of an external platform, the PFID of the external platform is stored in the PFID field of the target record.

The company ID field contains the company ID of the company whose product part number is managed on the platform identified by the PFID stored in the PFID field. The part number field contains the part number of the product of the company identified by the company ID stored in the company ID field. The pseudo part number field contains the pseudo part number of the product of the company identified by the company ID stored in the company ID field. If no pseudo part number is assigned, “None” may be entered in the pseudo part number field. None” may be expressed with any information.

The control unit 201 receives notification information from the external platform via the communication unit 202. The notification information is information that indicates the correspondence between the part number of each product managed in the external platform and the pseudo-part number of each product assigned in the external platform. The notification information includes the PFID, company ID, and information indicating the correspondence between the part number and the pseudo part number. The control unit 201 updates the part number information maintained in the part number information DB 204 using the received notification information. In other words, the control unit 201 stores data in the PFID field, the company ID field, the part number field, and the pseudo part number field by receiving notification information.

The control unit 201 generates a pseudo part number for the subject product if the part number of the subject product is not specified to be disclosed in the tree information maintained in the tree information DB 203. In this case, the control unit 201 may generate different pseudo part numbers for each company to which the product information of the target product is released based on predetermined generation rules. The control unit 201 may also generate pseudo part numbers by referring to the part number information held in the part number information DB 204 to avoid duplication.

In one example, when generating a pseudo part number for a target product in accordance with the prescribed generation rules, the control unit 201 determines whether any of the records with the PFID of the external platform have the part number of the target product. The control unit 201 obtains the corresponding pseudo part number when the part number of the target product is stored in the part number field for the external platform in the part number information. The control unit 201 then generates a pseudo part number for the subject product that does not overlap with the pseudo part number in the acquired external platform. This allows the control unit 201 to generate a pseudo-part number for the subject product that does not overlap with the existing pseudo-part number on the external platform.

Any rule can be adopted as a predetermined generation rule. In one example, a given generation rule may consist of generating a randomly generated symbol sequence as a pseudo part number. In another example, the predetermined generation rule may consist of feeding the part number and company ID to a predetermined hash function and adopting the result (hash value) obtained as a pseudo part number. In yet another example, the predetermined generation rule may consist of generating a pseudo part number by assigning an arbitrary symbol string, such as a numerical sequence according to the company, to the predetermined character string. If the pseudo-part number generated by the prescribed generation rules overlaps with the pseudo-part number on the external platform, the control unit 201 may discard the overlapping pseudo-part number and generate a new pseudo-part number that does not overlap with the pseudo-part number on the external platform, using any method. Optional methods may be, for example, using a different generation rule, referring to a list of pseudo part numbers in an external platform, etc.

When the control unit 201 generates a pseudo part number for the target product, it updates the part number information held in the part number information DB 204. In one example, the control unit 201 generates a new record that stores the PFID of its own platform in the PFID field, the company ID of the target company in the company ID field, the part number of the target product in the part number field, the generated pseudo part number in the pseudo part number field, and the generated Add the record to the part number information. In another example, the control unit 201 may generate a new record in the part number information and then store each of the above values in each field of the generated record. This allows the correspondence between the part number of the target product and the pseudo-part number to be ascertained by referring to the part number information.

In one example, the control unit 201 may send notification information to an external platform via the communication unit 202. Notification information may be sent at any timing, for example, when part number information is updated or at a pre-specified point in time. The notification information is information indicating the correspondence between the part number of the subject product and the newly generated pseudo part number by the control unit 201. This allows the external platform to assign a pseudo-part number to the target product so that it does not overlap with the pseudo-part number of the target product on its own platform.

### Data Processing

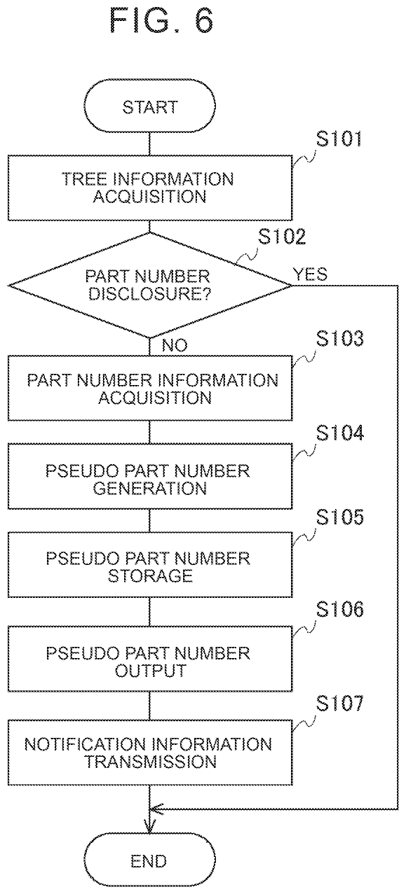

FIG. 6 is a flowchart of the process executed by the control unit 201 in the server 200. The process shown in FIG. 6 is used to assign a pseudo product number to the subject product. The process shown in FIG. 6 is initiated when the administrator of server 200 or other person inputs a command to server 200 to manage the part number of the target product.

In the process shown in FIG. 6, tree information is first obtained in S101. Next, in S102, the control unit 201 determines whether or not the part number of the target product has been designated in the tree information to be released to the company to which the product information is to be released. If a positive decision is made in S102, the part number of the target product is designated to be released to the company to which the product information is to be released. Therefore, the process shown in FIG. 6 is terminated. If a negative decision is made in S102, a pseudo part number must be assigned to the subject product. Therefore, in S103, the part number information is obtained. Next, in S104, a pseudo part number is generated. At this time, the pseudo-part number of the subject product is generated in accordance with the prescribed generation rules so that it does not overlap with the existing pseudo-part number included in the part number information. This allows for the generation of different pseudo part numbers for each company that publishes product information for the target product on the platform containing the server 200. In addition, the pseudo-part number can be assigned to the target product so that it does not overlap with the pseudo-part number of the target product on the external platform.

Next, in S105, the correspondence between the part number of the target product and the pseudo-part number is stored in the part number information held in the part number information DB 204. Next, in S106, the pseudo product number is output to the corporate terminal 100 associated with the company producing the subject product. This allows the company producing the subject product to ascertain the pseudo part number. The output of pseudo part numbers also includes the release of pseudo part numbers of the subject product to downstream companies. Next, in S107, the notification information is notified to the external platform. The process shown in FIG. 6 is then completed.

As explained above, in the information processing system 1, pseudo part numbers that differ from the part number of the target product are generated differently for each company to which the product information of the target product is released. This makes it difficult to identify the status of transactions of the subject product between the company handling the product and other companies, while making it difficult to identify the status of transactions of the subject product. In this way, it is possible to manage the status of transactions of the subject product while ensuring the confidentiality of the transaction status of the subject product.

### Modified Examples

In this embodiment, the server 200 is configured to retain information on the pseudo part numbers generated on the external platform and generate pseudo part numbers for the subject product so that they do not overlap with the existing pseudo part numbers on the external platform. In addition, server 200 is configured to notify external platforms of the generated pseudo part numbers. In other words, the server 200 is configured to work with external platforms. External platform linkages need not be limited to this.

In one example, server 200 may receive the generation rules for pseudo part numbers on an external platform and generate pseudo part numbers for the target product based on the generation rules. As a specific example, the control unit 201 may receive, via the communication unit 202, the rules for generating pseudo part numbers on external platforms. The control unit 201 may then generate pseudo part numbers for the subject product using the same generation rules as the rules for generating pseudo part numbers on the external platform. Generation rules may be, for example, the use of a predetermined hash function, the addition of an arbitrary symbol string to a predetermined string, etc. This allows the control unit 201 to assign a pseudo part number to the subject product using the same rules as the pseudo part number of the subject product on the external platform. As a result, it is possible to standardize the format of pseudo part numbers across platforms, facilitating the management of part numbers. It is preferable that the control unit 201 generates pseudo-part numbers using the generation rules obtained from the external platform to avoid duplication with pseudo-part numbers already existing on its own platform and on the external platform.

In another example, the control unit 201 may transmit the predetermined generation rules to an external platform via the communication unit 202. In other words, the control unit 201 may send to the external platform the generation rules that are stored in advance in the server 200 and used to generate the pseudo part numbers. This allows pseudo part numbers to be generated on external platforms using the same rules as the server 200. As a result, similar to the above, it is possible to standardize the format of pseudo part numbers across platforms, facilitating the management of part numbers.

In other variations, at least one of the above linkages to external platforms may be omitted. The configuration of the part number information is not limited to the above examples and may be changed arbitrarily, as long as the correspondence between the part number and the pseudo-part number can be maintained. If it is not necessary to maintain a correspondence between the part number and the pseudo-part number, the part number information may be omitted.

In addition, the product information of each company may include information indicating the tie relationship of at least one of the upstream and downstream products related to the company's target product (tie information). In this case, the tree information may consist of tied information held separately as product information for each company.

In the above embodiment, server 200 is an example of an information processing device. However, the form of the information processing device need not be limited to this and may be selected arbitrarily. In another example, at least some processing of the server 200 may be performed by the terminals of each company. Typically, all of the above processes of server 200 may be performed at each company's terminal. Accordingly, the information for each company maintained by the server 200 may be maintained on each company's terminal. In this case, the terminal of each company is an example of an information processing device. Server 200 may be omitted. In another example, server 200 may hold identifiable product information, and the terminals of each company may exchange information peer-to-peer, depending on the information held on server 200. In this case, the process of generating the pseudo part numbers in the above embodiment may be performed by at least one of the server 200 and each company's terminal.

### Other Embodiments

The above-described embodiments are mere examples, and the present disclosure can be implemented with appropriate modifications within a range not departing from the scope thereof. Moreover, the processes and units described in the present disclosure can be freely combined and implemented unless technical contradiction occurs.

Further, the processes described as being executed by one device may be shared and executed by a plurality of devices. Alternatively, the processes described as being executed by different devices may be executed by one device. In the computer system, it is possible to flexibly change the hardware configuration (server configuration) for realizing each function.

The present disclosure can also be implemented by supplying a computer with a computer program that implements the functions described in the above embodiment, and causing one or more processors of the computer to read and execute the program. Such a computer program may be provided to the computer by a non-transitory computer-readable storage medium connectable to the system bus of the computer, or may be provided to the computer via a network. Examples of the non-transitory computer-readable storage medium include a random disk (such as a magnetic disk (a floppy (registered trademark) disk, an HDD, and the like) or an optical disc (such as a CD-ROM, a DVD disc, and a Blu-ray disc)), a ROM, a RAM, an EPROM, an EEPROM, a magnetic card, a flash memory, an optical card, and a random type of medium suitable for storing electronic instructions.

What is claimed is:

1. An information processing device comprising a control unit that is configured to execute:
with regard to a target product of a target company, obtaining designation of whether to release a part number managed by the target company to a company to which product information of the target product is released;
when it is designated that the part number is not to be released, generating a different pseudo part number for each of the companies to which the product information of the target product is released; and
outputting the generated pseudo part number instead of the part number.

2. The information processing device according to claim 1, wherein the control unit is configured to further execute:
generating part number management information indicating a correspondence between the part number and the pseudo part number; and
storing the part number management information in a predetermined storage area.

3. The information processing device according to claim 1, wherein:
the control unit is further configured to execute obtaining a generation rule of the pseudo part number on an external platform; and
generating the pseudo part number includes generating the pseudo part number in accordance with the obtained generation rule.

4. The information processing device according to claim 1, wherein:
generating the pseudo part number includes generating the pseudo part number in accordance with a predetermined generation rule; and
the control unit is further configured to execute notifying an external platform of the predetermined generation rule.

5. The information processing device according to claim 1, wherein:
the control unit is further configured to execute obtaining a list of pseudo part numbers that are already assigned to the target product on an external platform; and
generating the pseudo part number includes generating the pseudo part number such that the pseudo part number does not overlap any of the pseudo part numbers included in the obtained list.
